(19) United States
(12) Patent Application Publication
(10) Pub. No.: US 2026/0188553 A1
(43) Pub. Date: Jul. 2, 2026

(54) Magnetic Components Featuring Graphite Laminate Layers for Enhanced Heat Transfer and Dissipation

(71) Applicant: Hong Kong Applied Science and Technology Research Institute Company Limited, Hong Kong (HK)

(72) Inventors: Pratik Limbu, Hong Kong (HK); Bhoopal Ponnuvelu, Hong Kong (HK); Tin Ho LI, Hong Kong (HK)

(21) Appl. No.: 19/005,044

(22) Filed: Dec. 30, 2024

(51) Int. Cl. H01F 27/22; H01F 17/04

(52) U.S. Cl. CPC H01F 27/22; H01F 17/045

(57) ABSTRACT

An inductor has a core with an air gap that prevents heat transfer across the air gap from an upper core to a lower core. The cores have an E-shaped cross section, with a center post or bobbin that wire is wrapped around, and a left leg and a right leg that are not wrapped with wires. Adhesive is applied to a graphite sheet to attach the graphite sheet to outer sides of the left and right legs. The graphite-adhesive laminate sheet crosses the air gap, allowing heat to be transferred across the air gap. Graphite sheets are not attached to the bobbin. Thermally-conductive particles such as carbon nanotubes can be added to the adhesive. Several inductors can be stacked together laterally. A heat sink attached to the lower core can dissipate heat generated by the upper core by heat transfer through the graphite sheet crossing the air gap.

### FIELD OF THE INVENTION

This invention relates to inductors with magnetic cores, and more particularly to heat transfer across an air gap in an inductor core.

### BACKGROUND OF THE INVENTION

Magnetic components such as inductors and transformers are often used in power converters such as Switched-Mode Power Supplies (SMPS).

FIG. 1 shows an inductor with a magnetic core. An inductor has a long insulated wire wrapped around a magnetic core. A transformer is a type of inductor with two or more windings around the core, such as a primary winding and a secondary winding that are electrically isolated but coupled magnetically. Traditionally, the magnetic core is made of iron or ferrite and is shaped as a cylinder.

A more advanced inductor has an E-shaped core or E-core. In FIG. 1, wire 120 are wrapped around center post or bobbin 106 of an E-core. The E-core has upper core 104 and lower core 108 that each have a cross-section that looks like the letter E. For example, upper core 104 has a cross section that looks like a letter E rotated to point downward, while lower core 108 has a cross section that looks like a letter E rotated to point upward (FIG. 4).

Bobbin 106 is the center of the E cross sections while the sides of upper core 104 and lower core 108 partially surround wires 120. Bobbin 106 can be square or round in the many variations of E-cores. Wire 120 is more easily wrapped around a round bobbin 106 than a square bobbin 106. E-core inductors can provide lower core losses even at higher temperature, higher efficiency due to better magnetic coupling, lower manufacturing costs, a compact design to overcome space constraints, and easier assembly for prototyping and testing.

Upper core 104 and lower core 108 are separated by air gap 100. Air gap 100 can prevent saturation and allow for a higher magnetic flux and energy storage.

FIG. 2 shows an inductor core. Wires 120 have been removed in FIG. 2 to show upper core 104 and lower core 108 in better detail. Rather than being rectangular, bobbin 106 can have a cylindrical shape to better allow wires 120 to wrap around in a coil shape. Air gap 100 is present in bobbin 106 as well as the two sides of upper core 104 and lower core 108.

FIG. 3 shows the inductor mounted to a heat sink. Heat sink 112 can be attached to the bottom of lower core 108, either directly as shown or indirectly through a Printed-Circuit Board (PCB) that has metal heat pipes or other heat transfer components passing through the PCB to conduct heat from lower core 108 to heat sink 112.

Note that upper core 104 is not attached to any heat sink. High-density power converters often are cramped and do not allow for heat sinks on both upper and lower cores of an inductor.

FIG. 4 is a cross-section of the inductor of FIGS. 1-3. Upper core 104 is E-shaped and is separated from E-shaped lower core 108 by air gap 100. Bobbin 106 is also divided by air gap 100. Wires 120 (not shown) are wrapped around bobbin 106 in voids 116 between bobbin 106 and the ends of upper core 104 and lower core 108.

Heat sink 112 is attached to the bottom of lower core 108. Heat sink 112 can remove heat from lower core 108. Air flow can be forced across fins on the lower surface of heat sink 112 to enhance heat removal. However, heat generated in upper core 104 cannot easily be removed to heat sink 112 because air gap 100 hinders heat transfer.

FIG. 5 shows heat transfer within the inductor of FIGS. 1-4. When current passes through wires 120, wires 120 heat up due to resistance in the long wires. Also, when Alternating Current (AC) is applied to wires 120, the magnetic flux reverses as the AC current changes direction. These magnetic flux reversals can have hysteresis and can cause eddy currents within upper core 104 and lower core 108. Heating from these eddy currents is greatest where the magnetic flux is the most dense, in bobbin 106.

This heat generated by resistances in wires 120 and by flux reversals in bobbin 106 increases the temperature of upper core 104 and lower core 108. However, heat from lower core 108 can be transferred to heat sink 112, reducing the temperature of lower core 108. However, air gap 100 prevents or significantly reduces heat transfer from upper core 104 to lower core 108. Thus upper core 104 can have a higher temperature than lower core 108.

Upper core 104 can be as much as 40 C. higher in temperature than lower core 108. This higher temperature in upper core 104 is undesirable since overheating can cause failures and reduce service lifetime of the inductor and other nearby components.

What is desired is an inductor with better heat transfer. An indictor with enhanced heat transfer across an air gap between upper and lower E-cores is desirable. An air-gap inductor with a laminate coating to transfer heat across the air gap is desired.

### BRIEF DESCRIPTION OF THE DRAWINGS

FIG. 1 shows an inductor with a magnetic core.

FIG. 2 shows an inductor core.

FIG. 3 shows the inductor mounted to a heat sink.

FIG. 4 is a cross-section of the inductor of FIGS. 1-3.

FIG. 5 shows heat transfer within the inductor of FIGS. 1-4.

FIG. 6 shows an E-core inductor with a heat-transfer laminate attached to the outer faces of the core sides.

FIG. 7 shows an E-core inductor with a graphite-adhesive laminate attached to the outer surfaces of E-core.

FIG. 8 is a cross-section of an E-core inductor with graphite sheets attached to outer surfaces to transfer heat across the air gap.

FIG. 9 highlights heat transfer across the air gap by the graphite sheets.

FIG. 10 shows graphite laminate sheets also attached to front and back surfaces of the side legs of the E-cores.

FIG. 11 shows graphite laminate sheets attached to all outer surface of the E-core.

FIG. 12 shows the graphite laminate sheet in more detail.

FIG. 13 shows a graphene layer in graphite.

FIG. 14 shows a process for forming an adhesive layer on a graphite sheet to form a graphite laminate sheet.

FIG. 15 shows the graphite laminate layer in more detail.

FIGS. 16A-16B show attaching a single graphite laminate sheet to four outer sides of the inductor.

FIG. 17 highlights the single large graphite sheet being applied to upper core 32 and lower core 34.

FIG. 18 shows 3 inductor cores laminated together with laminate graphite sheets.

FIG. 19 shows a stacked inductor with graphite rings between inductor cores.

FIG. 20 shows the stacked inductor attached to a heat sink.

FIGS. 21A-21B shows different core types.

FIG. 22 shows a stacked inductor with five cores.

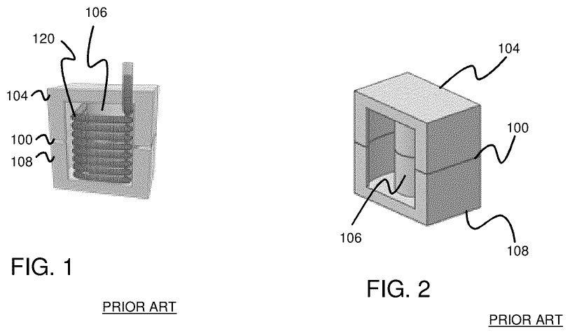

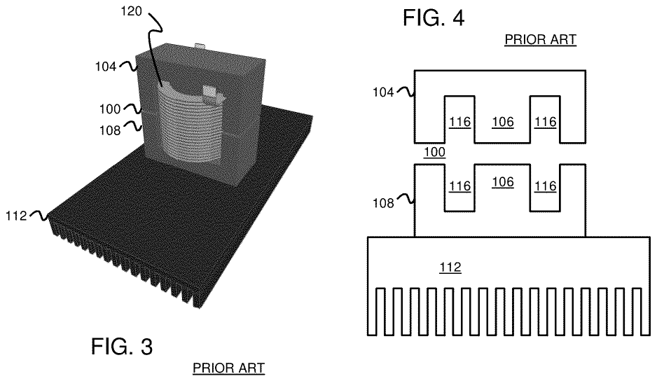

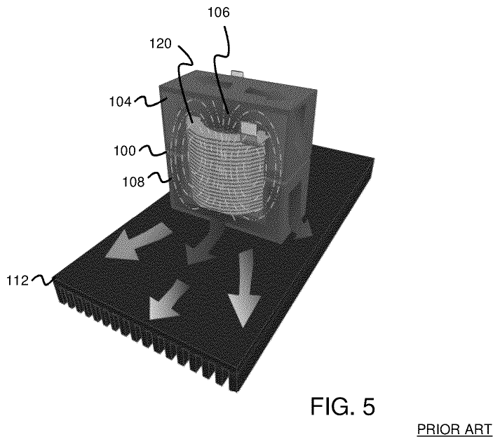

### DETAILED DESCRIPTION

The present invention relates to an improvement in inductors. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

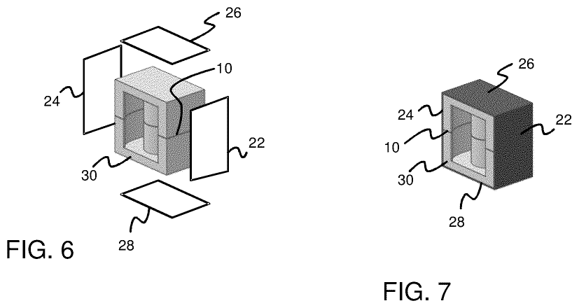

FIG. 6 shows an E-core inductor with a heat-transfer laminate attached to the outer faces of the core sides. Inductor 30 is an E-core inductor with upper and lower cores separated by air gap 10. A long wire (not shown) is wrapped around the bobbin 106 of inductor 30. The side legs of the upper and lower cores partially surround the wire coil wrapped around the bobbin 106.

Graphite sheets 22, 24, 26, 28 are laminate sheets, each with a graphite layer and an adhesive layer laminated together. Graphite sheet 22 has its adhesive layer pressed into the outer surface of the right side legs of the upper and lower cores. Graphite sheet 24 has its adhesive layer pressed into the outer surface of the left side legs of the upper and lower cores. Graphite sheet 26 has its adhesive layer pressed into the outer top surface of the upper core, while graphite sheet 28 has its adhesive layer pressed into the outer top surface of the lower core.

Graphite sheet 22 straddles air gap 10 that separates the right legs of the upper and lower cores. Likewise, graphite sheet 24 straddles air gap 10 that separates the left legs of the upper and lower cores. The adhesive layer ensures that the overlaying graphite layer of the laminate sheet sticks to the outer surfaces of the magnetic core.

FIG. 7 shows an E-core inductor with a graphite-adhesive laminate attached to the outer surfaces of E-core. Inductor 30 has graphite sheets 22, 24, 26, 28 attached to four outer surfaces of the upper and lower E-cores. Graphite has good heat transfer characteristics, allowing heat to be transferred from the upper core across air gap 10 to the lower core. Graphite sheet 22 crosses air gap 10 in the right leg of the E-cores, while graphite sheet 24 crosses air gap 10 on the left leg of the E-cores.

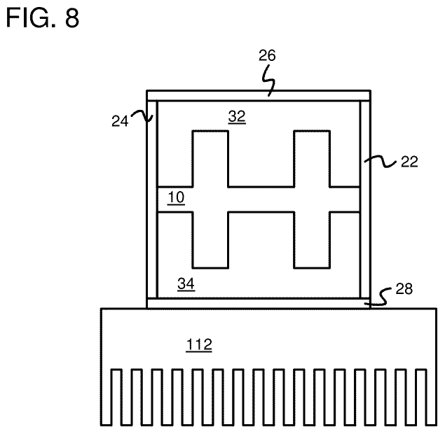

FIG. 8 is a cross-section of an E-core inductor with graphite sheets attached to outer surfaces to transfer heat across the air gap. Upper core 32 and lower core 34 are E-shaped ferrite cores with a long wire (not shown) wrapped around their bobbins. Graphite sheet 22 is attached to the outer surface of the right legs of upper core 32 and lower core 34 so that graphite sheet 22 covers the right side of air gap 10. Graphite sheet 24 is attached to the outer surface of the left legs of upper core 32 and lower core 34 so that graphite sheet 24 covers the left side of air gap 10.

Graphite sheet 26 is attached by its adhesive to the top surface of upper core 32, while graphite sheet 28 is attached by its adhesive to the bottom surface of lower core 34. Heat sink 122 can be attached to graphite sheet 28 by another adhesive layer or can simply be pressed together and held in place by connectors or fasteners such as screws or bolts.

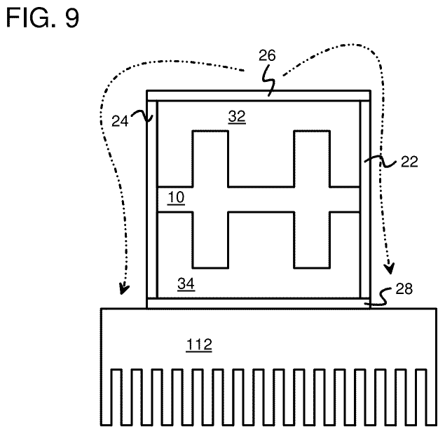

FIG. 9 highlights heat transfer across the air gap by the graphite sheets. During operation, the bobbins of upper core 32 and lower core 34 heat up due to eddy currents in the ferrite core and due to resistance heating of the long wires wrapped around the bobbin. This heat from the bobbin flows outward through upper core 32 to the left and right side legs of upper core 32. Some heat from the bobbin also is conducted to graphite sheet 26 and then flows along the top of the inductor and into graphite sheets 22, 24 on the sides.

Some heat conducted along top graphite sheet 26 and more heat conducted from the left side leg of upper core 32 is conducted into left graphite sheet 24. This heat in left graphite sheet 24 is conducted downward across air gap 10 and into the left leg of lower core 34, or into bottom graphite sheet 28 and into heat sink 112. Thus heat from the bobbin of upper core 32 is conducted through graphite sheets 26, 24, 28 and into heat sink 112, where cooling fins can dissipate the heat into forced air.

Other heat conducted rightward along top graphite sheet 26 and more heat conducted from the right side leg of upper core 32 is conducted into right graphite sheet 22. This heat in right graphite sheet 22 is conducted downward across air gap 10 and into the right leg of lower core 34, or into bottom graphite sheet 28 and into heat sink 112. Thus heat from the bobbin of upper core 32 is also conducted through graphite sheets 26, 22, 28 and into heat sink 112, where cooling fins can dissipate the heat into forced air.

Graphite sheets 22, 24 bridge air gap 10, allowing heat transfer from upper core 32 to lower core 34. Heat is more uniformly distributed within the inductor, reducing hot spots and thermal failures. Heat sink 112 can remove this heat when a fan forces air to flow across fins on heat sink 112.

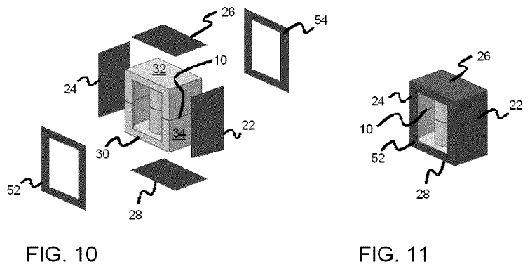

FIG. 10 shows graphite laminate sheets also attached to front and back surfaces of the side legs of the E-cores. Front graphite sheet 52 has a back-facing adhesive layer that is pressed into the front face of upper core 32 and lower core 34. Back graphite sheet 54 has a front-facing adhesive layer that is pressed into the back face of upper core 32 and lower core 34. Front graphite sheet 52 and back graphite sheet 54 are not pressed into the bobbin.

FIG. 11 shows graphite laminate sheets attached to all outer surface of the E-core. While graphite laminate sheets are not attached to the bobbin where the long wire is wound around, graphite sheets 22, 24, 26 attach to the outer top and side surfaces of upper core 32, while graphite sheets 22, 24, 28 attach to the outer bottom and side surfaces of lower core 34. Graphite sheets 22, 24 cross the air gap.

Front graphite sheet 52 is a square ring attached to the front surfaces of upper core 32 and lower core 34. Back graphite sheet 54 is a square ring attached to the back or rear surfaces of upper core 32 and lower core 34.

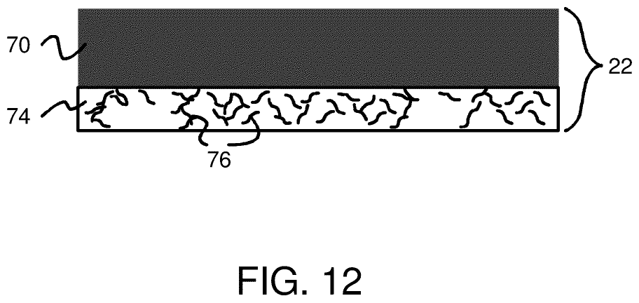

FIG. 12 shows the graphite laminate sheet in more detail. Graphite sheet 22 is a laminate having graphite layer 70 and adhesive layer 74. Adhesive layer 74 can be an acrylic tape that is attached to graphite layer 70. The thermal conductivity of adhesive layer 74 can be enhanced by adding thermally conductive particles 76 to adhesive layer 74. For example, thermally conductive particles 76 can be carbon nanotubes.

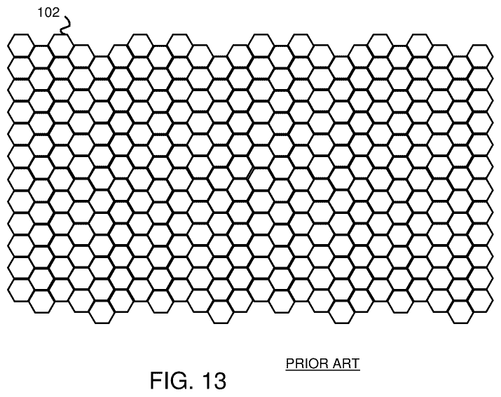

FIG. 13 shows a graphene layer in graphite. Graphite has many layers of graphene 102 that are stacked together like a stack of papers. However, clumps of stacked layers of graphene 102 may have different orientations. Graphene 102 has carbon atoms in a flat planar hexagonal pattern. Graphite has good heat transfer and electrical conductivity.

Ferrite cores provide good magnetic properties but are electrically insulating. If conductive graphite layers 22, 24 are placed within or in-between the air gap, the magnetic flux across the air gap is affected, reducing the effective saturation. Eddy current may be induced on the conductor resulting in higher power loss. When graphite layers 22, 24 are around or just outside the air gap, there is less interference with the magnetic field, avoiding eddy current losses. Since cores are often made of material that does not conduct electricity, such as ferrite, having an electric conductor such as graphite layers 22, 24 straddle air gap 10 does not cause any electrical shorts or problems.

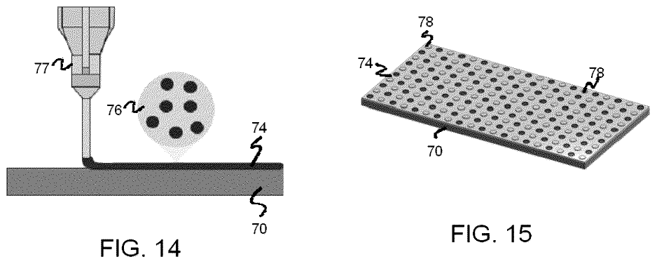

FIG. 14 shows a process for forming an adhesive layer on a graphite sheet to form a graphite laminate sheet. Graphite layer 70 can be a graphite sheet that is commercially available. As graphite layer 70 is rolled along, such as by a conveyor, nozzle 77 squirts liquid adhesive onto the top surface of graphite layer 70, forming adhesive layer 74 on top of graphite layer 70. Thermally conductive particles 76 can be mixed with the liquid adhesive before the mixture is input to nozzle 77. Mechanical mixing could be supplemented with ultrasonic mixing to better disperse thermally conductive particles 76 within the adhesive.

Thus adhesive layer 74 contains thermally conductive particles 76 that are randomly distributed within adhesive layer 74.

FIG. 15 shows the graphite laminate layer in more detail. Adhesive layer 74 has been printed onto the top of graphite layer 70. Micro bumps 78 are formed on adhesive layer 74 to enhance adhesion. Micro bumps 78 can be adhesive dots or bumps that are printed onto the top of adhesive layer 74 by stencil, special, or 3D printing. A matrix of additional nozzles could be used to print micro bumps 78 onto adhesive layer 74.

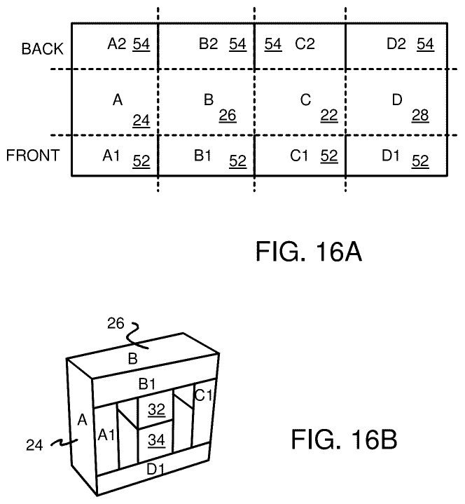

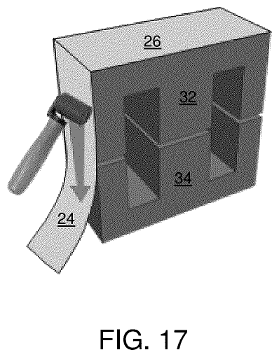

FIGS. 16A-16B show attaching a single graphite laminate sheet to four outer sides of the inductor. In FIG. 16A, a single large graphite sheet with adhesive applied is folded on the daashed lines. Thus folds are made between sections A, B, C, D, which correspond to graphite sheets 24, 26, 22, 28, respectively.

Cuts are made on the solid lines. Thus cuts are made between sections A2, B2, C2, and D2 back graphite sheet 54. Cuts are also made between sections A1, B1, C1, and D1 in front graphite sheet 52.

In FIG. 16B, after the cuts are made to the single large graphite sheet, this sheet is applied to the outer surfaces of upper core 32 and lower core 34. Section A forms left graphite sheet 24, while section B forms top graphite sheet 26. Section C forms right graphite sheet 22 and section D forms bottom graphite sheet 28 (not shown).

Once section A has been applied to the left legs of upper core 32 and to lower core 34, then section A1 can be folded over the left front edge of upper core 32 and lower core 34 and pressed into the top front surface of upper core 32 and lower core 34 to form a portion of front graphite sheet 52. Section C1 can be folded over the right front edge of upper core 32 and lower core 34 to form the right portion of front graphite sheet 52.

Then section B1 can be folded over the top front edge of upper core 32 and pressed into the top front surface of upper core 32 to form a portion of front graphite sheet 52. Section D1 can be folded over the bottom front edge of lower core 34 to form the bottom portion of front graphite sheet 52.

Sections A2, C2 can likewise be folded over the back surfaces of upper core 32 and lower core 34, followed by folding section B2 over the back of upper core 32 and folding section D2 over the back of lower core 34. Thus a single graphite sheet can be folded and cut and applied to these outer surfaces of upper core 32 and lower core 34, forming graphite sheets 22, 24, 26, 28, 52, 54 from a single graphite sheet.

FIG. 17 highlights the single large graphite sheet being applied to upper core 32 and lower core 34. Section B can first be pressed into the top surface of upper core 32, such as by using a pressure roller or a squeegee. The pressure being applied helps to press the adhesive into the surface of upper core 32, flattening the graphite sheet and removing air bubbles. Then after section B is applied to form top graphite sheet 26, the large graphite sheet is folded over to the left surface of upper core 32 and lower core 34, and the pressure roller or squeegee presses this portion of the graphite sheet into the left surfaces of upper core 32 and lower core 34 to form left graphite sheet 24.

This use of the pressure roller or squeegee can continue to form right graphite sheet 22 and bottom graphite sheet 28. Then sections A1, B1, C1, D1 can be folded over the front edges of upper core 32 and lower core 34 to form front graphite sheet 52. Finally sections A2, B2, C2, D2 can be folded over the back edges of upper core 32 and lower core 34 to form back graphite sheet 54.

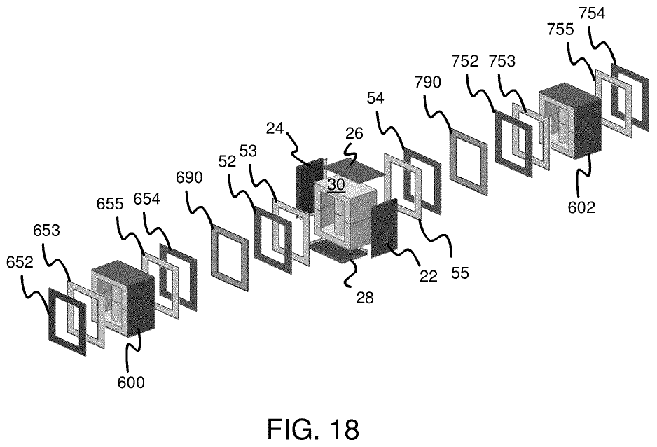

FIG. 18 shows 3 inductor cores laminated together with laminate graphite sheets. Inductor 30 can be formed by pressing graphite-adhesive sheets onto the outer surfaces of upper core 32 and lower core 34, forming right graphite sheet 22, left graphite sheet 24, top graphite sheet 26, bottom graphite sheet 28, front graphite sheet 52, and back graphite sheet 54. A larger graphite sheet such as shown in FIG. 16A-16B can be used to wrap inductor 30. All of graphite sheets 22, 24, 26, 28, 52, 54 have adhesive attached to inner surfaces facing cores 32, 34, such as front adhesive sheet 53 and back adhesive sheet 55.

Several assemblies identical to inductor 30 with its graphite sheets 22, 24, 26, 28, 52, 54 attached can be constructed. Front inductor 600 and back inductor 602 each have graphite sheets cladding their outer surfaces, as does inductor 30.

Front inductor 600 has right, left, top, and bottom graphite sheets attached. Front inductor 600 also has front graphite sheet 652 attached by front adhesive ring 653, and back graphite sheet 654 attached by back adhesive ring 655.

Back inductor 602 has right, left, top, and bottom graphite sheets attached. Back inductor 602 also has front graphite sheet 752 attached by front adhesive ring 753, and back graphite sheet 754 attached by back adhesive ring 755.

Laminating rings 690, 790 are adhesive rings that laminate the core assemblies together. Laminating ring 690 has adhesive that adheres front inductor 600 to the front of inductor 30, while laminating ring 790 adheres back inductor 602 to the back of inductor 30. More particularly, laminating ring 690 is sandwiched between rear graphite sheet 654 and front graphite sheet 52. Likewise, laminating ring 790 is sandwiched between rear graphite sheet 54 and front graphite sheet 752.

Front inductor 600 can be pressed into inductor 30, causing adhesives in laminating ring 690 to be squeezed between rear graphite sheet 654 and front graphite sheet 52 to form a good bond with low contact resistance. Then the assembly of front inductor 600 and inductor 30 can be pressed into back inductor 602, causing adhesives in laminating ring 790 to be squeezed between rear graphite sheet 52 and front graphite sheet 752 to form a good bond with low contact resistance.

This pressing can be performed by loosely fitting inductor 30, front inductor 600, and back inductor 602 together with laminating rings 690, 790, and then applying force to the two ends of the entire sandwich of layers and inductor cores.

Graphite rings 52 allows for lateral heat transfer from the front of inductor 30. Graphite ring 654 allows for lateral heat transfer from front inductor 600.

Likewise, graphite ring 54 allows lateral heat transfer from the back of inductor 30. Graphite ring 752 allows lateral heat transfer from back inductor 602.

Thus heat can be transferred laterally among the laminated inductor cores through the intermediate graphite rings 52, 654, 54, 752.

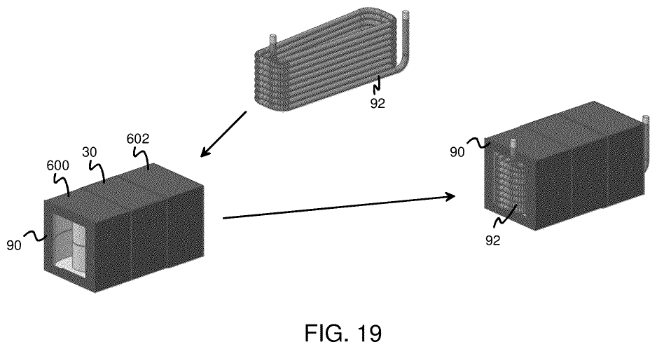

FIG. 19 shows a stacked inductor with graphite rings between inductor cores. Stacked inductor 90 has three inductor cores that are laminated together.

Inductor 30, front inductor 600, and back inductor 602 each have graphite-adhesive laminate sheets applied to their outer surface but not to their bobbins (bobbins) that wire 92 is wrapped around. Wire 92 is wrapped around all 3 bobbins for each winding.

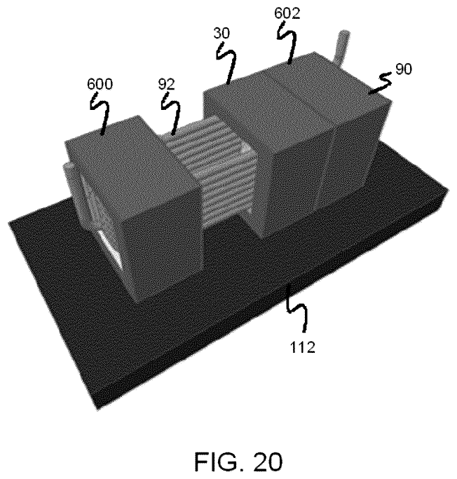

FIG. 20 shows the stacked inductor attached to a heat sink. A gap is shown in stacked inductor 90 between front inductor 600 and inductor 30 to expose wires 92 for viewing, but normally front inductor 600 would be pressed into inductor 30 with graphite ring 52 and its adhesive layers in between. All three of inductor 30, front inductor 600, and back inductor 602 are attached to heat sink 112. Heat generated by inductor 30 can travel downward across the air gap between upper core 32 and lower core 34 through right graphite sheet 22 and left graphite sheet 24. This heat then transfers to bottom graphite sheet 28 and then into heat sink 112 for dissipation by forced air.

Likewise, heat generated by front inductor 600 and back inductor 602 can cross their air gaps using graphite sheets 622, 722, (FIG. 18) and then be transferred downward into heat sink 112.

Graphite rings 52, 54 (FIG. 18) also allow heat transfer downward across the air gaps, but also allow heat transfer laterally from inductor 30 to front inductor 600 and to back inductor 602.

Inductor 30 in the middle would normally have more heat trapped since it cannot dissipate that heat laterally, only downward to a heat sink. But graphite ring 52 allows heat at the front surface of inductor 30 to be transferred laterally, cross the front air gap, and then down into heat sink 112 under inductor 30. Similarly, graphite ring 54 allows heat at the back surface of inductor 30 to be transferred laterally, cross the back air gap, then down into heat sink 112 under inductor 30. Thus more heat is effectively removed from inductor 30.

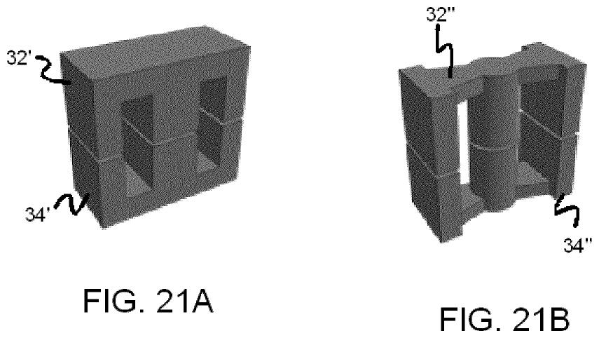

FIGS. 21A-21B shows different core types. FIG. 21A shows a traditional E-core that has a rectangular bobbin formed from the middle leg of upper core 32′. and lower core 34′. This rectangular bobbin or bobbin is undesirable since the wires are more difficult to wrap around a square bobbin. Also, having the bobbin have the same thickness as the side legs causes the wires wrapped around the bobbin to stick out past the side legs.

Many variations of E-cores are available. Some E-cores have round bobbins, allowing for easier wire wrapping. Also the wires are less likely to break at the corners of the square bobbin when the bobbin is round. This improves reliability. The depth of the bobbin can be reduced to allow the left and right side legs to extend past the wires wrapped around the bobbin.

FIG. 21B shows a PQ core. A PQ core is a variation of the E-core and can be considered to be a type of E-core. In the PQ core, upper core 32″ and lower core 34″ are adjusted in shape. The center post or bobbin is round to allow for easier wire wrapping. The left and right side legs are deeper than the bobbin. The shape of the PQ core can be optimized for Switched-Mode Power Supplies (SMPS) or other AC applications.

When a PQ core is used, right graphite sheet 22 and left graphite sheet 24 can be applied as rectangles, but top graphite sheet 26 and bottom graphite sheet 28 may need to be cut to fit the shapes of the top of upper core 32″ and the shape of lower core 34″. Alternately, a rectangle could be used for top graphite sheet 26 and for bottom graphite sheet 28, and the graphite sheet being larger or smaller than the top of upper core 32″. front graphite sheet 52 and back graphite sheet 54 may be deleted or reduced in size, such as to only cover the left and right legs and not the top and bottom near the bobbin.

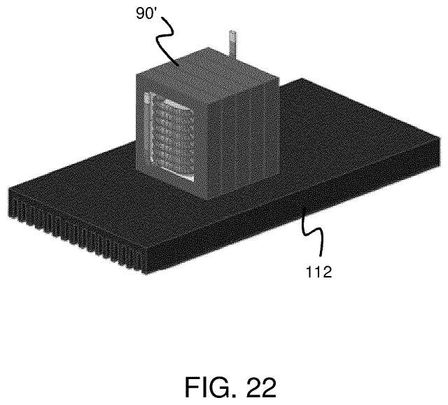

FIG. 22 shows a stacked inductor with five cores. While FIG. 18 has shown three inductor cores connected laterally by two graphite rings, more cores can be included in stacked inductor 90′. In this example there are 5 cores and 4 graphite rings between them. The size of heat sink 112 can be enlarged for the additional heat and size of stacked inductor 90′ with five cores.

### Alternate Embodiments

Several other embodiments are contemplated by the inventors. For example many combinations and variations of the upper and lower cores are possible. Some of the graphite-adhesive laminate sheets may be deleted in some embodiments or may be cut to different shapes.

While an E core and a PQ core variation have been described, many variations of the magnetic core are possible, such as pot cores where the sides are extended to more completely surround bobbin 106, U-shaped cores that are missing the second side leg, El cores where the upper core is an E-core and the lower core is rectangular or l shaped, RM cores, RS cores, DS cores, etc. Many extensions of E-cores and hybrid shapes and combinations are possible, such as EER cores, ETD cores, EP cores, EC cores, EFF cores, El cores, etc. The invention can be applied to any core shape, size, and core material because the graphite sheet is highly flexible.

While a core with a bobbin, a left leg, and a right leg has been shown, the core might have only one leg and the bobbin. For a magnetic core rod, first the graphite sheet is attached to the core rod. Then, some insulation tape is wrapped on top of the graphite sheet. Finally, the winding is wound around the rod. The legs might be extended toward each other and merge in the back to form a semicircle. The air gap could be present in the bobbin and in one leg, but not in the other leg. The air gap could be located near the bottom, rather than halfway between the top and bottom. Other variations of the air gap are possible. There could be multiple air gaps or more than two core sections in the inductor.

The core may be made from material such as iron, iron oxides, ferrite, ferrite ceramics, silicon steel, amorphous steel, neodymium, powdered iron or other material. Ceramic may also be used. Examples of ferromagnetic core material include: Silicon steel, Powered iron, nickel-iron alloy, amorphous metal, etc. Examples of non-ferromagnetic core material include: Manganese ferrites, Non-magnetic ceramics, Polymers. The core may be made from ferromagnetic or from non-ferromagnetic materials. Ferrite is a generic name referring to the mixture of iron-oxide and other metal oxides. Other materials refers may include different mixture such as Amorphous.

The air gap in the magnetic core may have small spacers at corners to maintain a desired gap thickness. These spacers may be ceramic or other non-conducting material. The air gap could be filled with a dielectric material or spacer that is not an electrical and magnetic conductor, such as PET tape or FR4. However, the air gap is normally filled with air.

The air gap may be in the middle of the inductor as shown, or may be offset from the center, such as nearer to the bottom of the inductor than to the top of the inductor. The upper core can be larger than the lower core when the air gap is shifted downward. The air gap could be at the bottom of the bobbin, and the lower core could be a bar rather than an E-shape, such as for an El core inductor.

While graphite sheets have been shown that are attached to all outer surfaces of the E-cores, graphite sheet 26 attached to the top surface of the upper core and graphite sheet 28 attached to the lower surface of the lower core could be deleted, since graphite sheets 26, 28 do not cross air gap 10. While graphite sheets 22, 24 have been shown that completely cover the outer surfaces of the left and right legs of the E-cores, the size of graphite sheets 22, 24 could be reduced to only partially cover the sides of the E-cores. Graphite sheets 22, 24 could be reduced in size to only cover air gap 10 and parts of the upper and lower E-core sides. Heat would still be transferred across air gap 10, although not as efficeitnly as when graphite sheets 22, 24 are larger in size, attaching to a larger surface area of the E-core sides. Graphite sheet 28 on the bottom could be deleted when good contact to heat sink 112 is otherwise provided, such as through connectors.

The thermally conductive particles can be carbon nanotubes, ceramic powder, Silicon carbide, Alumina, Boron oxide, Magnesium oxide, or other material that conducts heat. The adhesive provides a low contact resistance to the graphite sheet, allowing the graphite sheet to make better contact with the surface of the inductor core, providing better heat transfer.

The outer edges of upper core 32 and lower core 34 can be rounded to allow the single large graphite sheet to better be fitted around the corners (FIG. 17). Sharp edges are more likely to break or weaken the graphite laminate. A coating can be applied to the inductor after the graphite sheets are attached to protect the graphite laminates from scratching, abrasion, or damage. Microbumps (FIG. 15) in the adhesive can be added for better adhesion, or may be deleted for a simpler process. Many process methods and variations are possible.

While two graphite rings 52, 654 have been shown in FIG. 18 between front inductor 602 and inductor 30, there could be a single graphite sheet with adhesive on both sides.

While graphite sheets have been shown that are thermally conductive, other thermally conductive materials could be substituted for graphite. The conductive sheet can be any thermally conductive thin film such as copper, silicone, aluminum, etc. or a mixture of graphite and other materials. However, they may not be as effective as the graphite sheet in improving the thermal performance

Terms such as up, down, above, under, horizontal, vertical, inside, outside, are relative and depend on the viewpoint and are not meant to limit the invention to a particular perspective. Devices may be rotated so that vertical is horizontal and horizontal is vertical, so these terms are viewer dependent.

The background of the invention section may contain background information about the problem or environment of the invention rather than describe prior art by others. Thus inclusion of material in the background section is not an admission of prior art by the Applicant.

Any methods or processes described herein are machine-implemented or computer-implemented and are intended to be performed by machine, computer, or other device and are not intended to be performed solely by humans without such machine assistance. Tangible results generated may include reports or other machine-generated displays on display devices such as computer monitors, projection devices, audio-generating devices, and related media devices, and may include hardcopy printouts that are also machine-generated. Computer control of other machines is another tangible result.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. An inductor comprising:
an upper core of magnetic material having a top portion, an upper leg extending downward from the top portion, and an upper bobbin extending downward from the top portion;
a lower core of magnetic material having a bottom portion, a lower leg extending upward from the bottom portion, and a lower bobbin extending upward from the bottom portion;
a bobbin air gap between the upper bobbin and the lower bobbin;
a leg air gap between the upper leg and the lower leg;
a graphite sheet laminate having an adhesive attached to an inner surface of a graphite sheet, the graphite sheet laminate being attached by the adhesive to an outer surface of the upper leg and being attached by the adhesive to an outer surface of the lower leg, the graphite sheet laminate straddling the leg air gap; and
a wire that is wrapped multiple times around the upper bobbin and is wrapped multiple times around the lower bobbin;
wherein heat generated at the upper bobbin is transferred through the top portion to the upper leg, and transferred to the graphite sheet laminate and across the leg air gap to the lower leg of the lower core,
whereby the graphite sheet laminate transfers heat across the leg air gap from the upper core to the lower core.

2. The inductor of claim 1 wherein the outer surface of the upper leg is a surface facing away from the upper bobbin;
wherein the outer surface of the lower leg is a surface facing away from the lower bobbin;
wherein the graphite sheet laminate is attached to outer surfaces;
wherein the graphite sheet laminate is not attached to an inner surface of the upper leg that faces the upper bobbin;
wherein the graphite sheet laminate is not attached to an inner surface of the lower leg that faces the lower bobbin.

3. The inductor of claim 2 wherein the upper core further comprises a second upper leg extending downward from the top portion on a second end of the top portion that is opposite to a first end of the top portion having the upper leg extending downward;
wherein the lower core further comprises a second lower leg extending upward from the bottom portion on a second end of the bottom portion that is opposite to a first end of the bottom portion having the lower leg extending upward;
wherein the upper bobbin is situated between the upper leg and the second upper leg;
wherein the lower bobbin is situated between the lower leg and the second lower leg.

4. The inductor of claim 3 wherein the upper core has a cross-section that has an E-shape;
wherein the lower core has a cross-section that has an E-shape;
wherein the inductor is an E-core inductor.

5. The inductor of claim 4 wherein the upper bobbin has a thickness that is less than a thickness of the upper leg;
wherein the lower bobbin has a thickness that is less than a thickness of the lower leg.

6. The inductor of claim 5 wherein the inductor is a PQ-core inductor.

7. The inductor of claim 4 further comprising:
a heat sink, attached to the lower core, the heat sink for dissipating heat to air forced over the heat sink;
wherein heat from the lower core is transferred to the heat sink;
wherein heat from the upper core is transferred through the graphite sheet laminate to the lower core and then to the heat sink.

8. The inductor of claim 7 further comprising:
a bottom graphite sheet laminate having an adhesive attached to an inner surface of a graphite sheet, the bottom graphite sheet laminate being attached by the adhesive to an bottom surface of the bottom portion of the lower core, the bottom graphite sheet laminate for transferring heat from the lower core to the heat sink.

9. The inductor of claim 8 further comprising:
a top graphite sheet laminate having an adhesive attached to an inner surface of a graphite sheet, the top graphite sheet laminate being attached by the adhesive to a top surface of the top portion of the upper core.

10. The inductor of claim 9 further comprising:
a second leg air gap between the second upper leg and the second lower leg;
a second graphite sheet laminate having an adhesive attached to an inner surface of a graphite sheet, the second graphite sheet laminate being attached by the adhesive to an outer surface of the second upper leg of the upper core, the second graphite sheet laminate also being attached by the adhesive to an outer surface of the second lower leg of the lower core;
wherein the second graphite sheet laminate straddles the second leg air gap;
wherein heat generated at the upper bobbin is transferred through the top portion to the second upper leg, and transferred to the second graphite sheet laminate and across the second leg air gap to the second lower leg of the lower core,
whereby the second graphite sheet laminate also transfers heat across the second leg air gap from the upper core to the lower core.

11. The inductor of claim 10 further comprising:
a front graphite sheet laminate having an adhesive attached to an inner surface of a graphite sheet having a ring shape, the front graphite sheet laminate being attached by the adhesive to front outer surfaces of the upper leg, the second upper leg, the top portion of the upper core, and the bottom portion of the lower core, the front graphite sheet laminate not being attached to the upper bobbin or to the lower bobbin;
a back graphite sheet laminate having an adhesive attached to an inner surface of a graphite sheet having a ring shape, the back graphite sheet laminate being attached by the adhesive to back outer surfaces of the upper leg, the second upper leg, the top portion of the upper core, and the bottom portion of the lower core, the back graphite sheet laminate not being attached to the upper bobbin or to the lower bobbin.

12. The inductor of claim 11 wherein the adhesive is mixed with thermally conducting particles.

13. The inductor of claim 12 wherein the thermally conducting particles are carbon nanotubes.

14. The inductor of claim 11 further comprising:
microbumps formed on the adhesive, the microbumps being thicker areas of the adhesive for improving adhesion of the graphite sheet to surfaces of the upper core or the lower core.

15. The inductor of claim 11 wherein the graphite sheet laminate, the top graphite sheet laminate, the second graphite sheet laminate, the bottom graphite sheet laminate, the front graphite sheet laminate, and the back graphite sheet laminate are each portions of a continuous graphite sheet laminate that is folded and cut to fit around the upper core and around the lower core.

16. The inductor of claim 15 wherein edges of the upper core and edges of the lower core are rounded to prevent sharp edges from wearing the continuous graphite sheet laminate at the edges of the upper core and at edges of the lower core.

17. The inductor of claim 11 wherein a second adhesive layer is also applied to an outer surface of the graphite sheet having the ring shape of the front graphite sheet laminate;
further comprising:
a front upper core having a same shape as the upper core, and having graphite sheet laminates attached to outer surfaces, the front upper core being attached by the second adhesive layer to the front graphite sheet laminate;
a front lower core having a same shape as the lower core, and having graphite sheet laminates attached to outer surfaces, the front lower core being attached by the second adhesive layer to the front graphite sheet laminate;
a front laminating ring of adhesive applied between the front upper core and the upper core, the front laminating ring of adhesive having the ring shape of the front graphite sheet laminate;
a back upper core having a same shape as the upper core, and having graphite sheet laminates attached to outer surfaces, the back upper core being attached by the second back adhesive layer to the back graphite sheet laminate;
a back lower core having a same shape as the lower core, and having graphite sheet laminates attached to outer surfaces, the back lower core being attached by the second back adhesive layer to the back graphite sheet laminate;
a back laminating ring of adhesive applied between the back upper core and the upper core, the back laminating ring of adhesive having the ring shape of the back graphite sheet laminate.

18. The inductor of claim 17 wherein the wire is wrapped multiple times around the upper bobbin of the front upper core, the upper core, and the back upper core, wherein the wire is wrapped around the upper bobbin of the front upper core, the upper core, and the back upper core for each winding loop;
wherein the wire is wrapped multiple times around the lower bobbin of the front lower core, the lower core, and the back lower core, wherein the wire is wrapped around the lower bobbin of the front lower core, the lower core, and the back lower core for each winding loop.

19. A thermally-enhanced inductor comprising:
an upper core made of ferrite or ferromagnetic material that has a top bar, an upper bobbin, an upper left leg, and an upper right leg, wherein the top bar is in a top plane, and the upper bobbin, the upper left leg, and the upper right leg are in a second plane that is perpendicular to the top plane, wherein the upper bobbin is between the upper left leg and the upper right leg and separated from the upper left leg and the upper right leg by an upper winding void;
an lower core made of ferrite or ferromagnetic material that has a bottom bar, a lower bobbin, a lower left leg, and a lower right leg, wherein the bottom bar is in a bottom plane that is parallel to the top plane, and the lower bobbin, the lower left leg, and the lower right leg are in the second plane, wherein the lower bobbin is between the lower left leg and the lower right leg and separated from the lower left leg and the lower right leg by a lower winding void;
a left air gap between a bottom of the upper left leg and a top of the lower left leg;
a right air gap between a bottom of the upper right leg and a top of the lower right leg;
a bobbin air gap between a bottom of the upper bobbin and a top of the lower bobbin;
a wire that is wound multiple times around the upper bobbin and is wound multiple times around the lower bobbin, the wire being wound in the upper winding void and in the lower winding void;
a left thermally-conducting laminate sheet applied to an outer surface of the upper left leg and applied to an outer surface of the lower left leg, the outer surface being a surface not facing the upper winding void or the lower winding void;
wherein the left thermally-conducting laminate sheet straddles the left air gap, the left thermally-conducting laminate sheet for transferring heat across the left air gap from the upper core to the lower core; and
a right thermally-conducting laminate sheet applied to an outer surface of the upper right leg and applied to an outer surface of the lower right leg, the outer surface being a surface not facing the upper winding void or the lower winding void;
wherein the right thermally-conducting laminate sheet straddles the right air gap, the right thermally-conducting laminate sheet for transferring heat across the right air gap from the upper core to the lower core;
wherein each thermally-conducting laminate sheet has an adhesive applied to a surface of a thermally-conducting layer that faces the upper core or the lower core, the adhesive for lowering contact resistance of the thermally-conducting layer to the ferrite or ferromagnetic material of the upper core or of the lower core;
whereby heat transfer from the upper core to the lower core across the left air gap is increased by the left thermally-conducting laminate sheet, and heat transfer across the right air gap is increased by the right thermally-conducting laminate sheet.

20. A thermally-enhanced stacked inductor comprising:
a plurality of cores, each core comprising:
an upper core made of ferrite or ferromagnetic material that has a top bar, an upper bobbin, an upper left leg, and an upper right leg, wherein the top bar is in a top plane, and the upper bobbin, the upper left leg, and the upper right leg are in a second plane that is perpendicular to the top plane, wherein the upper bobbin is between the upper left leg and the upper right leg and separated from the upper left leg and the upper right leg by an upper winding void;
an lower core made of ferrite or ferromagnetic material that has a bottom bar, a lower bobbin, a lower left leg, and a lower right leg, wherein the bottom bar is in a bottom plane that is parallel to the top plane, and the lower bobbin, the lower left leg, and the lower right leg are in the second plane, wherein the lower bobbin is between the lower left leg and the lower right leg and separated from the lower left leg and the lower right leg by a lower winding void;
a left air gap between a bottom of the upper left leg and a top of the lower left leg;
a right air gap between a bottom of the upper right leg and a top of the lower right leg;
a bobbin air gap between a bottom of the upper bobbin and a top of the lower bobbin;
a wire that is wound multiple times around the upper bobbin and is wound multiple times around the lower bobbin, the wire being wound in the upper winding void and in the lower winding void;
a left graphite laminate sheet applied to an outer surface of the upper left leg and applied to an outer surface of the lower left leg, the outer surface being a surface not facing the upper winding void or the lower winding void;
wherein the left graphite laminate sheet straddles the left air gap, the left graphite laminate sheet for transferring heat across the left air gap from the upper core to the lower core; and
a right graphite laminate sheet applied to an outer surface of the upper right leg and applied to an outer surface of the lower right leg, the outer surface being a surface not facing the upper winding void or the lower winding void;
wherein the right graphite laminate sheet straddles the right air gap, the right graphite laminate sheet for transferring heat across the right air gap from the upper core to the lower core;
wherein each graphite laminate sheet has an adhesive applied to a surface of a graphite layer that faces the upper core or the lower core, the adhesive for lowering contact resistance of the graphite layer to the ferrite or ferromagnetic material of the upper core or of the lower core;
between an adjacent pair of cores in the plurality of cores, a front graphite laminate sheet having the adhesive on both surfaces of the graphite layer, the front graphite laminate sheet having a ring shape;
wherein the front graphite laminate sheet is attached by the adhesive to front outer surfaces of the upper left leg, the upper right leg, the top bar of the upper core, and the lower left leg, the lower right leg, and the bottom bar of the lower core of a front-facing core of the adjacent pair of cores;
wherein the front graphite laminate sheet is attached by the adhesive to back outer surfaces of the upper left leg, the upper right leg, the top bar of the upper core, and the lower left leg, the lower right leg, and the bottom bar of the lower core of a back-facing core of the adjacent pair of cores;
wherein the front graphite laminate sheet is not attached to the upper bobbin or to the lower bobbin.
